(19) United States
(12) Patent Application Publication
(10) Pub. No.: US 2024/0355221 A1
(43) Pub. Date: Oct. 24, 2024

(54) SYSTEMS AND METHODS FOR SIMULATING STRING MANIPULATION

(71) Applicant: INTUITIVE SURGICAL OPERATIONS, INC., Sunnyvale, CA (US)

(72) Inventors: Woojin Ahn, Johns Creek, GA (US); Joey Chau, Cupertino, CA (US)

(21) Appl. No.: 18/684,105

(22) PCT Filed: Aug. 17, 2022
(86) PCT No.: PCT/US2022/040553

§ 371 Date: Feb. 15, 2024

Related U.S. Application Data
(60) Provisional application No. 63/234,766, filed on Aug. 19, 2021.

(51) Int. Cl. G09B 9/00; G06T 19/20

(52) U.S. Cl. CPC G09B 9/00; G06T 19/20; G06T 2219/2004; G06T 2219/2021

(57) ABSTRACT

A system comprises a processor and a memory having computer readable instructions stored thereon. The computer readable instructions, when executed by the processor, may cause the system to identify, from a plurality of linked elements, a first linked element connected by a joint to a second linked element and determine a current relative rotation of the second linked element with respect to the first linked element. The system may also determine if an angle of rotation associated with the current relative rotation is greater than a predetermined elastic limit for the joint. If the angle of rotation is greater than the predetermined elastic limit, a current plastic quaternion that represents a current angular plastic deformation of the joint is determined.

### CROSS-REFERENCED APPLICATIONS

This application claims priority to and the benefit of U.S. Provisional Application No. 63/234,766, filed Aug. 19, 2021 and entitled “Systems and Methods for Simulating String Manipulation,” which is incorporated by reference herein in its entirety.

### FIELD

Examples described herein are related to systems and methods for simulating string manipulation by considering angular plastic deformation using quaternions of discretized elements.

### BACKGROUND

Interactive computer-simulated exercises allow users to engage in simulated, real-time, interactive extended reality environments, gaming environments, and/or skill training environments. For example, surgeons or other medical clinicians may hone their skills in performing medical procedures in a virtual environment using interactive simulation exercises. Simulated medical procedures may be used to train clinicians on many types of procedures including open surgical procedures, minimally invasive procedures, and teleoperated or otherwise robot or computer assisted procedures. Efficient data processing techniques are needed to provide realistic, low latency computer simulations, especially for simulations of complex movements such as the movement of elastically and/or plastically deformable elongated string-type structures. Systems and methods for dynamic simulation of string manipulation may allow realistic clinician training for procedures such as suturing that involve manipulation of string-type structures.

### SUMMARY

The following presents a simplified summary of various examples described herein and is not intended to identify key or critical elements or to delineate the scope of the claims.

In one example, a system comprises a processor and a memory having computer readable instructions stored thereon. The computer readable instructions, when executed by the processor, may cause the system to identify, from a plurality of linked elements, a first linked element connected by a joint to a second linked element and determine a current relative rotation of the second linked element with respect to the first linked element. The system may also determine if an angle of rotation associated with the current relative rotation is greater than a predetermined elastic limit for the joint. If the angle of rotation is greater than the predetermined elastic limit, a current plastic quaternion that represents a current angular plastic deformation of the joint may be determined.

In another example, a non-transitory machine-readable medium comprises a plurality of machine-readable instructions which when executed by one or more processors associated with a computer-assisted simulation system are adapted to cause the one or more processors to perform a method. The method may comprise identifying, from a plurality of linked elements, a first linked element connected by a joint to a second linked element and determining a current relative rotation of the second linked element with respect to the first linked element. The method may also comprise determining if an angle of rotation associated with the current relative rotation is greater than a predetermined elastic limit for the joint. If the angle of rotation is greater than the predetermined elastic limit, a current plastic quaternion that represents a current angular plastic deformation of the joint may be determined.

It is to be understood that both the foregoing general description and the following detailed description are illustrative and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTIONS OF THE DRAWINGS

FIG. 1A illustrates a flexible string structure according to some examples.

FIG. 1B illustrates a portion of the flexible string structure of FIG. 1A modeled as a series of rigid and/or soft linked elements connected by joints according to some examples.

FIG. 1C illustrates a pair of the linked elements of FIG. 1B connected by a joint according to some examples.

FIG. 1D illustrates a torque-angle curve for a model undergoing clastic and plastic behaviors according to some examples.

FIG. 2 is a schematic illustration of a system for simulating string manipulation according to some examples.

FIGS. 3A, 3B, and 3C illustrate displayed graphical images of a string manipulation simulation according to some examples.

FIG. 4 is a flowchart illustrating a method for simulating string manipulation according to some examples.

FIG. 5 is a flowchart illustrating a method for determining angular plastic deformation quaternions at joints in modeled string structure, according to some examples.

FIG. 6 is a flowchart illustrating a method for determining a current relative rotation of a second linked element in a modeled string structure to a first linked element of the modeled string structure, according to some examples.

FIG. 7 is a flowchart illustrating a method for determining an angle of rotation associated with a current relative rotation of a second linked element in a modeled string structure with a respect to a first linked element in the modeled string structure, according to some examples.

FIG. 8 is a flowchart illustrating a method for determining if a deviated angle from a predetermined elastic limit is greater than a predetermined plastic limit for the linked elements.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Dynamic simulation of string manipulation in response to a user input may be used in a variety of simulated environments including interactive extended reality environments, gaming environments, and skill training environments. Although the technology described herein may refer to simulated manipulation of string-type structured in medical training environments in response to inputs from a clinician, the string manipulation simulation technology may be used in any of a variety of simulated environments.

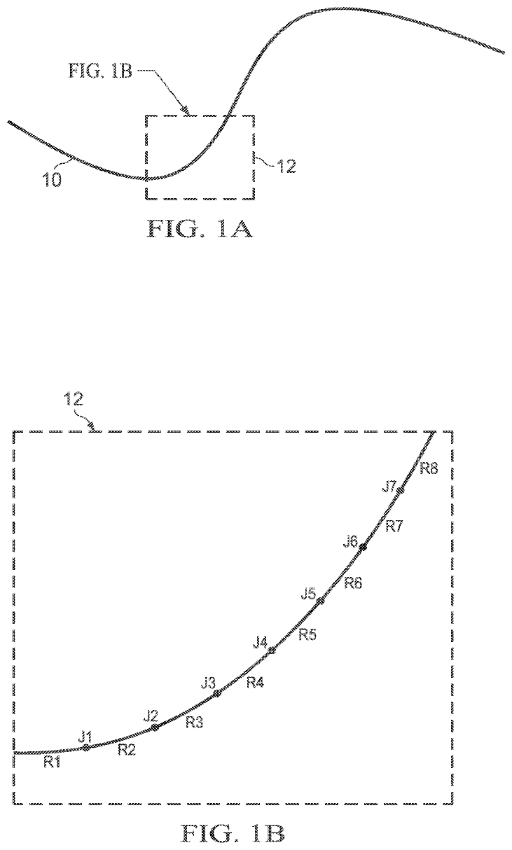

FIG. 1A illustrates a flexible string structure 10 according to some examples. The string structure 10 may be subject to forces that cause the flexible string structure 10 to bend. Such forces may be generated by manipulators (e.g., instruments or tools) in the environment, objects in the environment, gravity or other influences acting on the string structure 10. The string structure 10 may be formed from material that exhibits elastic and/or plastic deformation characteristics. Elastic deformation is temporary such that when the applied force causing the elastic deformation is removed, the string structure returns to its original shape. Plastic deformation occurs when solid material undergoes a permanent change in response to an applied force. In some examples, the string structure 10 may be formed from a suture material used in surgical or other medical procedures. Suture materials may include absorbable materials such as polydioxanone, poliglecaprone, polyglactin, and gut or non-absorbable materials such as nylon, polypropylene, silk, and polyester. Suture materials may include synthetic materials or natural materials and may be formed from monofilament or multifilament materials. Sutures may also have diameters ranging from, for example, 0.01 mm to 1.0 mm.

FIG. 1B illustrates a portion 12 of the flexible string structure 10 modeled as an articulated body including a series of discretized elements or linked elements (R1-R8), connected by joints (J1-J7). The linked elements may be modeled as rigid or flexible. The number of discretized elements into which the portion 12 may be divided may be greater than or fewer than the number of elements shown, with each discretized element having its own local frame of reference. Generally, the portion of the string structure may have a quantity i of linked elements where i varies from 1 to N, where N is the number of linked elements in an articulated body. Generally, the portion may have a quantity i of joints where i varies from 1 to M, where M is N−1.

FIG. 1C illustrates an example of an articulated body 20 including an example pair of the linked elements Ri, Ri+1 (e.g., linked elements R1, R2) connected by a joint Ji (e.g., joint J1) within a global frame of reference {G} with coordinates (X_{G}, Y_{G}, Z_{G}). The joint Ji may be a ball joint with three degrees of rotational freedom. Linked element Ri has a local frame of reference {i} (with coordinates (Xᵢ, Yᵢ, Zᵢ)), and linked element Ri+1 has a local frame of reference {i+1} (with coordinates (Xᵢ₊₁, Yᵢ₊₁, Zᵢ₊₁)). A unit quaternion qᵢ represents the rotation of linked element Ri with respect to the global frame of reference {G}. A unit quaternion qᵢ₊₁ represents the rotation of linked element Ri+1 with respect to the global frame of reference {G}. A quaternion may be expressed as a set of four values [W X Y Z] (e.g., qᵢ[wᵢ, xᵢ, yᵢ, zᵢ] and qᵢ₊₁[wᵢ₊₁, xᵢ₊₁, yᵢ₊₁, zᵢ₊₁]) that are used to specify a rotation in 3D space.

Each joint Jj may be modeled as a torsional spring that generates a restoring torque. For joint J1, the restoring torque may be a torque τ. The 3×1 torque vector for a given joint may be expressed as τ̅=kn̅=k log(q̅q̅₀⁻¹) where n̅ is the logarithmic map of the quaternion, q̅q̅₀⁻¹, that represents the deviation of q̅ from q̅₀. q̅ is the relative rotation of the frame {i+1} with respect to the frame {i}, where q̅=qᵢ⁻¹qᵢ₊₁. q̅₀ is the quaternion q̅ in the initial state. The overbar denotes a quaternion or vector with respect to the local frame. k is an angular stiffness coefficient. τ̅ is the vector with respect to the local frame {i} that is integrated into a dynamic equation of the system.

FIG. 1D illustrates a torque-angle curve 30 for an example model of an articulated body (e.g. articulated body 20) undergoing clastic and plastic behaviors. γ₁ may be an elastic constant. γ₂ may a plastic constant. The slope corresponds to the angular stiffness coefficient k. The articulated body may undergo elastic deformation in the elastic region 32 when an external torque τ is applied. The elastically deformed body may be restored to the original state when the external torque τ is removed. When the angle of deformation θ is bigger than the elastic constant γ₁, then the articulated body undergoes plastic deformation, which results in permanent deformation. When the external torque is removed, the articulated body is not restored to the original rotation, q̅₀. Instead it reaches the plastically deformed state that is represented by, q̅ₚ. Thus, the torque vector may be expressed as: τ̅=k n̅=k log(q̅q̅₀⁻¹). As described in greater detail below, q̅ₚ may be updated to simulate elastic and plastic behaviors of the articulated body. Without loss of generality, the articulated body may be straight at an initial state. It sets the initial q̅₀ and q̅ₚ to an identity quaternion I.

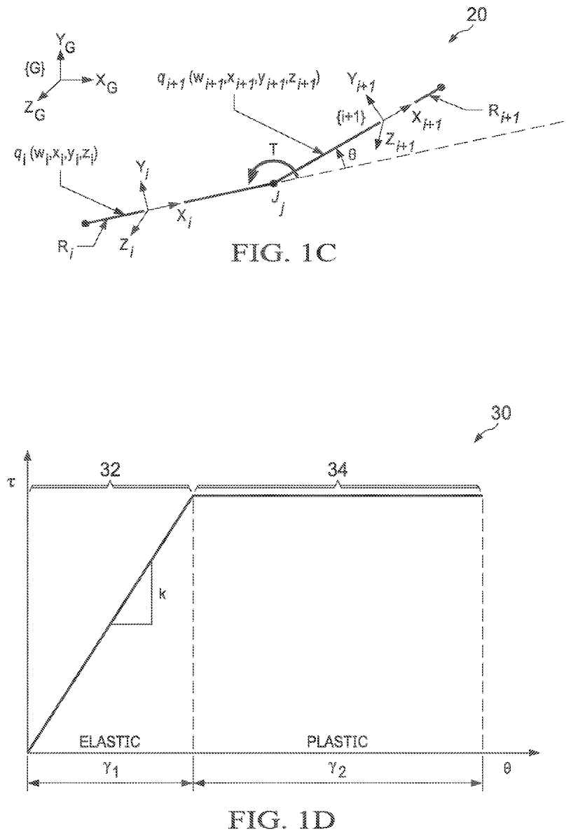

The motion of a flexible string structure, such as the flexible string structure 10 may be simulated with a simulation system 100. FIG. 2 illustrates the simulation system 100 which may include an operator interface system 102, a control system 104, and a display system 106. The operator interface system 102 may generally include one or more control device(s), which may be referred to as input control devices, for controlling a simulated instrument in a simulation environment. The control device(s) may include one or more of any number of a variety of input devices, such as hand grips, joysticks, trackballs, data gloves, trigger-guns, foot pedals, hand-operated controllers, voice recognition devices, touch screens, body motion or presence sensors, and other types of input devices.

The control system 104 includes at least one memory 108 and at least one processor 110 (which may be part of a processing unit) for generating a simulation environment and effecting control between the operator interface system 102, a simulated or virtual instrument in the simulation environment (e.g., 208, 210), and/or the display system 106. The control system 104 may include programmed instructions (e.g., stored on a non-transitory, computer-readable medium) to implement some or all of the methods described in accordance with aspects disclosed herein. While the control system 104 is shown as a single block in the simplified schematic of FIG. 2, the control system 104 may include two or more data processing circuits with one portion of the processing optionally being performed at the operator interface system 102. Any of a wide variety of centralized or distributed data processing architectures may be employed. Similarly, the programmed instructions may be implemented as a number of separate programs or subroutines, or they may be integrated into a number of other aspects of the systems described herein, including teleoperational systems. In one embodiment, the control system 104 supports wireless communication protocols such as Bluetooth, IrDA, HomeRF, IEEE 802.11, DECT, and Wireless Telemetry.

The display system 106 may include a single display screen, left and right eye display screens, a wearable device, and/or any other type of visual display that may generate monoscopic or stereoscopic graphical images.

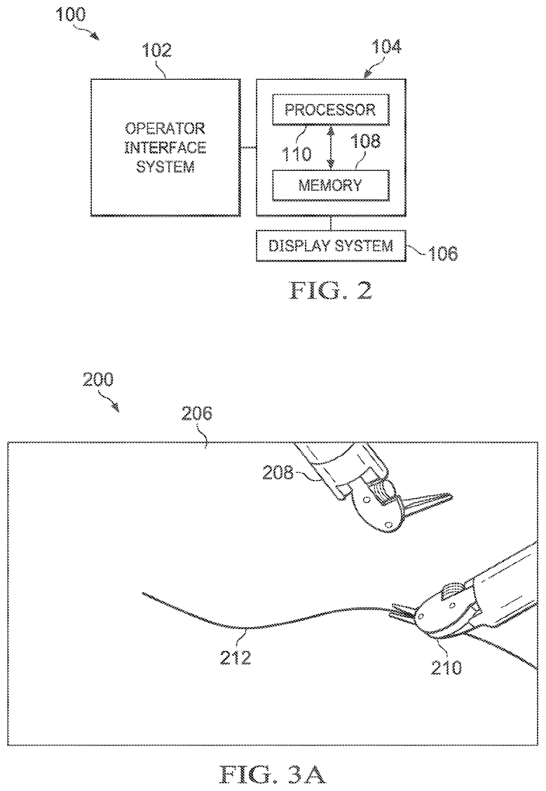

FIGS. 3A, 3B, and 3C illustrate an example of a series of displayed graphical images 200, 202, 204 of a string manipulation simulation. The images 200-204 may be displayed on the display system 106. The images 202-204 depict a simulation environment 206 including a simulated instrument 208, a simulated instrument 210, and a simulated string structure 212 (e.g. string structure 10). The simulated instruments 208, 210 may move in position and orientation in response to user inputs at an operator interface system (e.g., the operator interface system 102). As shown in the image 200, the string structure 212 may be gripped by the simulated instrument 210. As shown in the image 202, the string structure 212 may then be gripped by the simulated instrument 208, and forces may be applied by the simulated instruments 208, 210 to bend the string structure 212 into a bent shape 214. When one or more of the forces applies by the simulated instruments 208, 210 is removed, the string structure 212 may form a bent shape 216. The bent shape 216 may result from plastic deformation of the string structure caused by the applied forces. The bent shape 216 may be determined based on a number of factors including, for example, the forces applied by the simulated instruments 208, 210 to create the bent shape 214, forces provided by any other adjacent structures or matter in the simulated environment, the material properties of the string structure 212. The material properties of the string structure 212 may include the elastic and plastic deformation properties of the string structure 212.

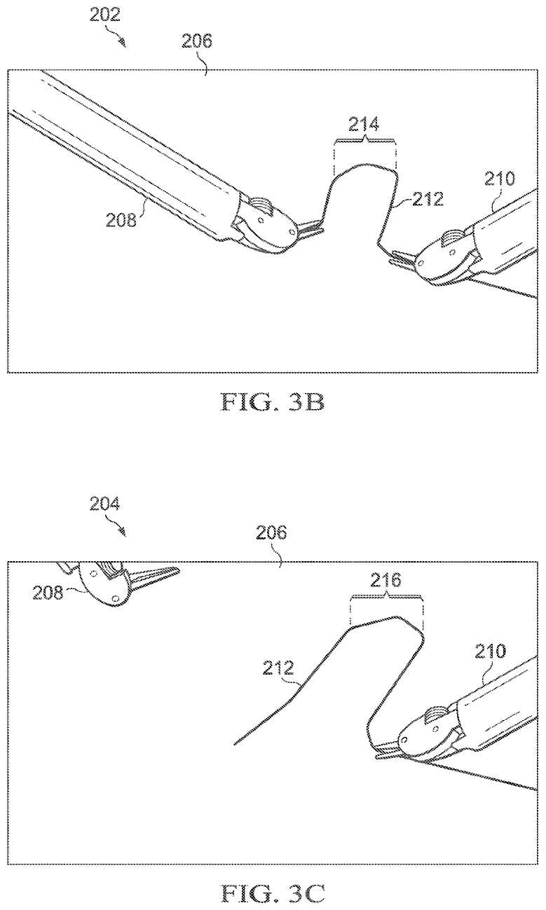

FIG. 4 is a flowchart illustrating an example method 300 for simulating string manipulation. The method 300 is illustrated as a set of operations or processes 302 through 314 and is described with continuing reference to the preceding figures.

At a process 302, linked elements of a quantity N (e.g., linked elements R1-R8) and joints of a quantity M (e.g., joints J1-J7) are identified for a discretized string model (e.g., model of string structure 10). At the process 302, one or more parameters associated with the string model and the simulation environment may also be identified. Such parameters may include material property parameters for the string model including, for example, the type of material, density, compressive strength, modulus of elasticity, maximum operating temperature, thermal conductivity, expansion properties, an elastic deformation limit associated with the string material, a plastic deformation limit associated with the string material. Environmental property parameters may include, for example, temperature, pressure, type and characteristics of surrounding gas and liquids, and proximity and characteristics of surrounding structures.

At a process 304, rotations are received for the identified linked elements Ri-RN. The rotations may be received as a set of quaternions [q₁, q₂, q₃, . . . q_{N}] that represent the rotations of the linked elements Ri-RN with respect to the global frame of reference {G} at a previous simulation time step (t-Δt).

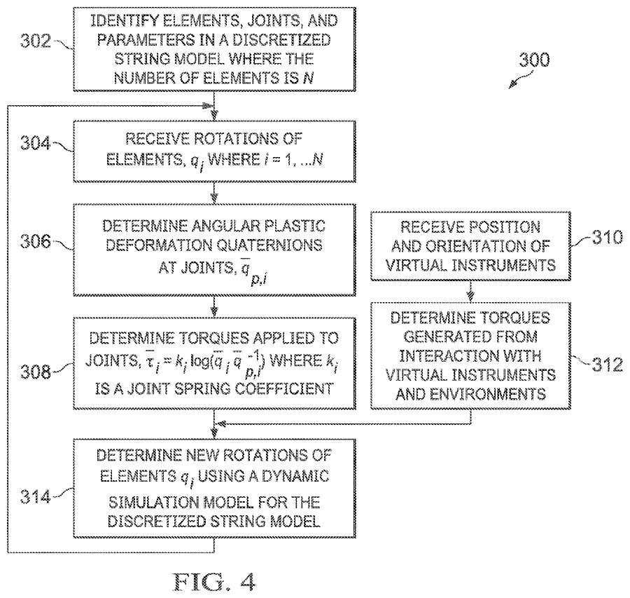

At a process 306, angular plastic deformation quaternions (q̅_{p,i}) are determined at the joints Ji-JM. The angular plastic deformation quaternions may represent the angular plastic deformation between two successive linked elements. For example, with reference to FIG. IC, the angular plastic deformation quaternion (q̅_{p,i}) at joint Ji may represent the angular plastic deformation of linked element Ri+1 and frame {i+1 } with respect to Ri and frame {i}. The process 306 may be described in greater detail in the method of FIG. 5.

At a process 308, the torques (τ̅ᵢ) applied to the joints Ji-JM may be determined. For example, at a joint Ji, torque (τ̅ᵢ)=kᵢ log(q̅q̅_{p,i}⁻¹), where kᵢ is a joint spring coefficient.

At a process 310, positions and orientations of simulated or virtual instruments (e.g., instruments 208, 210) in the global reference {G} may be determined. The positions and orientations of the virtual instruments may be determined from operator inputs to an operator interface system (e.g. operator interface system 102). In other words, operator inputs to the operator interface system may create control signals that move the virtual instruments in the simulated global reference {G} thus controlling their positions and orientations.

At a process 312, torques at the joints Ji-JM may be determined from the interaction of the linked elements Ri-RN with the virtual instruments and other forces in the simulated environment.

At a process 314, new rotations qi-qN of the linked elements Ri-RN may be determined from the torques generated from the interactions with the virtual instruments and environment at process 312 and from the torques applied to the joints at process 308. Those new rotations may be applied to the discretized string model and displayed on a display system (e.g. display system 106). By updating the discretized string model at successive iterations over time, a dynamic simulation model may be displayed.

The new rotations from process 314 may be received at process 304 and the processes 304-314 may be repeated as successive times t to update the dynamic simulation model.

FIG. 5 is a flowchart illustrating a method 400 for determining angular plastic deformation quaternions at joints in modeled string structure (e.g. process 306 of method 300). At a process 402, a joint (e.g., a joint J1) and two linked elements (e.g. linked elements R1 an R2) connected by the joint may be identified in a series of linked elements.

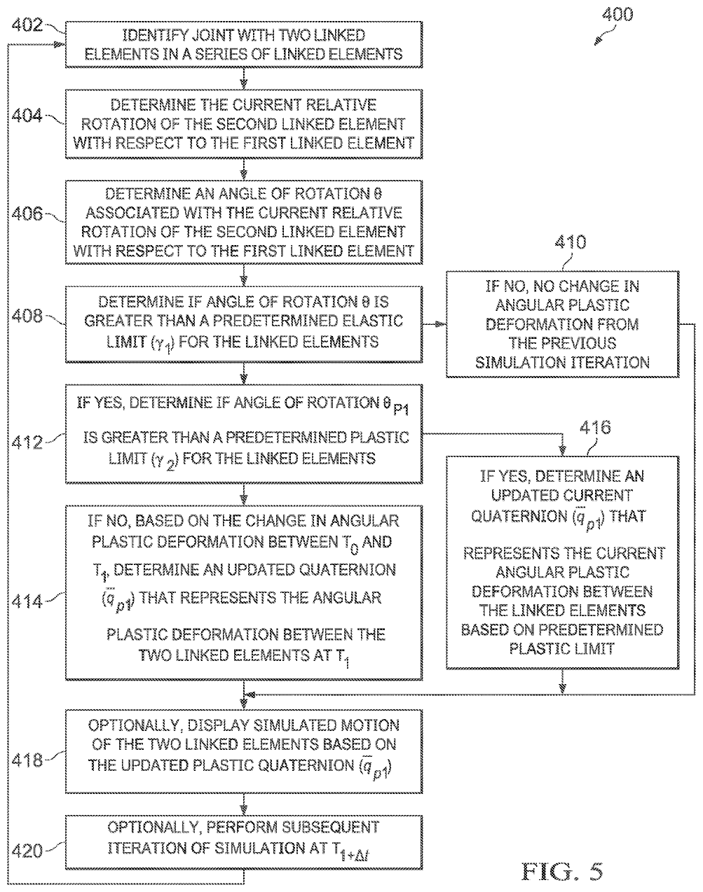

At a process 404, the current relative rotation of the second linked element with respect to the first linked element may be determined. Details of an example of the process 404 may be illustrated in the flowchart at FIG. 6. More specifically, FIG. 6 illustrates a process 430 in which a first quaternion (qᵢ) representing rotation of the first linked element is received and a second quaternion (qᵢ₊₁) representing rotation of the second linked element is received. At a process 432, the current relative rotation as a quaternion q̅ is determined as, q̅=qᵢ⁻¹qᵢ₊₁.

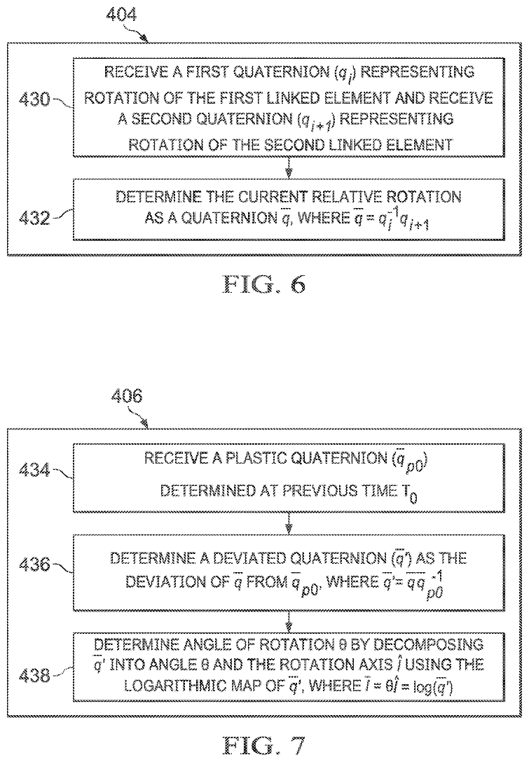

With reference again to FIG. 5, at a process 406, an angle of rotation θ associated with the current relative rotation of the second linked element with respect to the first linked element is determined. Details of an example of the process 406 may be illustrated in the flowchart at FIG. 7. More specifically, FIG. 7 illustrates a process 434 in which a plastic quaternion (q̅ₚ₀) determined at previous time T₀ is received. At a process 436, a deviated quaternion (q̅′) is determined as the deviation of q̅ from q̅ₚ₀, where q̅′=q̅q̅ₚ₀⁻¹. At a process 438, the angle of rotation θ may be determined by decomposing q̅′ into angle θ and the rotation axis \hat{l} using the logarithmic map of q̅′, where l̅=θ\hat{l}=log(q̅′).

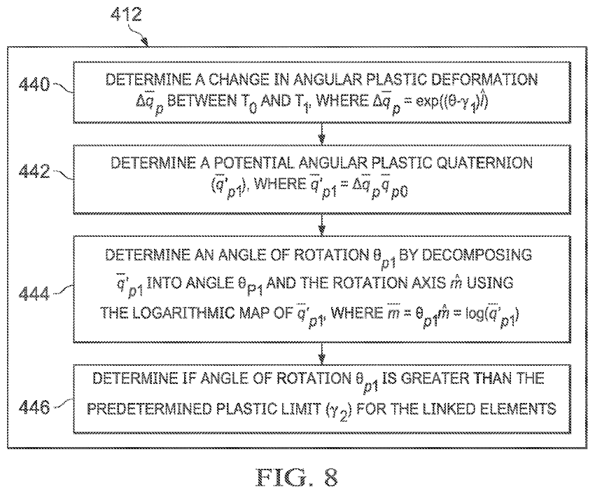

With reference again to FIG. 5, at a process 408, a determination is made as to whether the angle of rotation θ is greater than a predetermined elastic limit (γ₁) for the linked elements. At a process 410, if the angle of rotation θ is not greater than the predetermined elastic limit (γ₁) for the linked elements, no change in angular plastic deformation is determined from the previous simulation iteration. At a process 412, if the angle of rotation θ is greater than the predetermined elastic limit (γ₁) for the linked elements, a determination is made as to whether a plastic angle of rotation θ_{P1} is greater than a predetermined plastic limit (γ₂) for the linked elements. Details of an example of the process 412 may be illustrated in the flowchart at FIG. 8. More specifically, FIG. 8 illustrates a process 440 in which a change in angular plastic deformation Δq̅ₚ between time T₀ and time T₁ may be determined, where Δq̅ₚ=exp((θ−γ₁)\hat{l}). At a process 442, a potential angular plastic quaternion (q̅′ₚ₁) may be determined, where q̅′ₚ₁=Δq̅ₚΔq̅ₚ₀. At a process 444, an angle of rotation θₚ₁ is determined by decomposing q̅′ₚ₁ into angle θ_{P1}, and the rotation axis \hat{m} using the logarithmic map of q̅′ₚ₁, where m̅=θₚ₁\hat{m}=log(q̅′ₚ₁). At a process 446, a determination is made as to whether the angle of rotation θₚ₁ is greater than the predetermined plastic limit (γ₂) for the linked elements.

With reference again to FIG. 5, at a process 414, if a determination is made that the angle of rotation θ_{P1} is not greater than a predetermined plastic limit (γ₂) for the linked elements, then based on the change in angular plastic deformation between time T₀ and time T₁, an updated current plastic quaternion (q̅ₚ₁) is determined that represents the current angular plastic deformation between the two linked elements at time T₁. For example, the updated quaternion q̅ₚ₁ may be q̅′ₚ₁. At a process 416, if a determination is made that the angle of rotation θ_{P1} is greater than a predetermined plastic limit (γ₂) for the linked elements, then an updated current plastic quaternion (q̅ₚ₁) is determined that represents the angular plastic deformation between the linked elements based on predetermined plastic limit. For example, the updated quaternion q̅ₚ₁ may be based on predetermined plastic limit (γ₂), where q̅ₚ₁←exp(γ₂\hat{m}).

With reference again to FIG. 5, at an optional process 418, simulated motion of the two linked elements may be displayed based on the updated plastic quaternion (q̅ₚ₁). At an optional process 420, subsequent iterations of the simulation may be performed at time T₁₊_{_{Δ}}ₜ. At

The methods described herein are illustrated as a set of operations or processes. Not all of the illustrated processes may be performed in all embodiments of a described method. Additionally, one or more processes that are not expressly illustrated in a method may be included before, after, in between, or as part of the illustrated processes. In some embodiments, one or more of the processes may be implemented, at least in part, in the form of executable code stored on non-transitory, tangible, machine-readable media that when run by one or more processors (e.g., the processors of a control system) may cause the one or more processors to perform one or more of the processes. In one or more embodiments, the processes may be performed by the control system 104.

In this disclosure, specific words chosen to describe one or more embodiments and optional elements or features are not intended to limit the invention. For example, spatially relative terms—such as “beneath”, “below”, “lower”, “above”, “upper”, “proximal”, “distal”, and the like—may be used to describe one element's or feature's relationship to another element or feature as illustrated in the figures. These spatially relative terms are intended to encompass different positions (i.e., translational placements) and orientations (i.e., rotational placements) of a device in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. A device may be otherwise oriented (e.g., rotated 90 degrees or at other orientations) and the spatially relative descriptors used herein interpreted accordingly. Likewise, descriptions of movement along (translation) and around (rotation) various axes include various special device positions and orientations. The combination of a body's position and orientation define the body's pose.

In addition, the singular forms “a”, “an”, and “the” are intended to include the plural forms as well, unless the context indicates otherwise. And the terms “comprises,” “comprising,” “includes,” “has,” and the like specify the presence of stated features, steps, operations, elements, and/or components but do not preclude the presence or addition of one or more other features, steps, operations, elements, components, and/or groups. Components described as coupled may be electrically or mechanically directly coupled, or they may be indirectly coupled via one or more intermediate components. The auxiliary verb “may” likewise implies that a feature, step, operation, element, or component is optional.

Elements described in detail with reference to one embodiment, implementation, or application optionally may be included, whenever practical, in other embodiments, implementations, or applications in which they are not specifically shown or described. For example, if an element is described in detail with reference to one embodiment and is not described with reference to a second embodiment, the element may nevertheless be claimed as included in the second embodiment. Thus, to avoid unnecessary repetition in the following description, one or more elements shown and described in association with one embodiment, implementation, or application may be incorporated into other embodiments, implementations, or aspects unless specifically described otherwise, unless the one or more elements would make an embodiment or implementation non-functional, or unless two or more of the elements provide conflicting functions.

Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. In addition, dimensions provided herein are for specific examples and it is contemplated that different sizes, dimensions, and/or ratios may be utilized to implement the concepts of the present disclosure. To avoid needless descriptive repetition, one or more components or actions described in accordance with one illustrative embodiment can be used or omitted as applicable from other illustrative embodiments. For the sake of brevity, the numerous iterations of these combinations will not be described separately. For simplicity, in some instances the same reference numbers are used throughout the drawings to refer to the same or like parts.

Various instruments and portions of instruments have been described in terms of their state in three-dimensional space. As used herein, the term “position” refers to the location of an object or a portion of an object in a three-dimensional space (e.g., three degrees of translational freedom along Cartesian X, Y, Z coordinates). As used herein, the term “orientation” refers to the rotational placement of an object or a portion of an object (three degrees of rotational freedom-e.g., roll, pitch, and yaw).

Although some of the examples described herein refer to surgical procedures or instruments, or medical procedures and medical instruments, the techniques disclosed optionally apply to non-medical procedures and non-medical instruments. For example, the instruments, systems, and methods described herein may be used for non-medical purposes including industrial uses, general robotic uses, and sensing or manipulating non-tissue work pieces. Other example applications involve cosmetic improvements, imaging of human or animal anatomy, gathering data from human or animal anatomy, and training medical or non-medical personnel. Additional example applications include use for procedures on tissue removed from human or animal anatomies (without return to a human or animal anatomy) and performing procedures on human or animal cadavers. Further, these techniques can also be used for surgical and nonsurgical medical treatment or diagnosis procedures.

Further, although some of the examples presented in this disclosure discuss teleoperational robotic systems or remotely operable systems, the techniques disclosed are also applicable to computer-assisted systems that are directly and manually moved by operators, in part or in whole. A computer is a machine that follows programmed instructions to perform mathematical or logical functions on input information to produce processed output information. A computer includes a logic unit that performs the mathematical or logical functions, and memory that stores the programmed instructions, the input information, and the output information. The term “computer” and similar terms, such as “processor” or “controller” or “control system,” are analogous.

While certain exemplary embodiments of the invention have been described and shown in the accompanying drawings, it is to be understood that such embodiments are merely illustrative of and not restrictive on the broad invention, and that the embodiments of the invention not be limited to the specific constructions and arrangements shown and described, since various other modifications may occur to those ordinarily skilled in the art.

1. A system comprising:
a processor; and
a memory having computer readable instructions stored thereon, the computer readable instructions, when executed by the processor, cause the system to:
identify, from a plurality of linked elements, a first linked element connected by a joint to a second linked element;
determine a current relative rotation of the second linked element with respect to the first linked element;
determine if an angle of rotation associated with the current relative rotation is greater than a predetermined elastic limit for the joint; and
if the angle of rotation is greater than the predetermined elastic limit, determine a current plastic quaternion that represents a current angular plastic deformation of the joint.

2. The system of claim 1 wherein the computer readable instructions, when executed by the processor, further cause the system to display simulated motion of the first and second linked elements based on the current plastic quaternion.

3. The system of claim 1 wherein the plurality of linked elements models a surgical suture.

4. The system of claim 1 wherein the computer readable instructions, when executed by the processor, further cause the system to receive a material property parameter for the first and second linked elements and wherein determining the current relative rotation of the second linked element with respect to the first linked element includes determining the current relative rotation based on a torque applied to the joint and the material property parameter.

5. The system of claim 1 wherein determining the current relative rotation includes receiving a first quaternion representing rotation of the first linked element and receiving a second quaternion representing rotation of the second linked element.

6. The system of claim 5 wherein determining the current relative rotation includes representing the current relative rotation as a third quaternion.

7. The system of claim 1 wherein determining if the angle of rotation associated with the current relative rotation is greater than a predetermined elastic limit for the joint includes receiving a prior plastic quaternion for the joint and determining a deviated quaternion representing a deviation between the current relative rotation and the prior plastic quaternion.

8. The system of claim 1 wherein the computer readable instructions, when executed by the processor, further cause the system to determine a plastic angle of rotation and determine if the plastic angle of rotation is greater than a predetermined plastic limit for the joint.

9. The system of claim 8 wherein if the plastic angle of rotation is greater than the predetermined plastic limit, the computer readable instructions, when executed by the processor, further cause the system to determine a quaternion that represents the current angular plastic deformation based on the predetermined plastic limit.

10. The system of claim 1 wherein the computer readable instructions, when executed by the processor, further cause the system to
receive orientations of virtual instruments and
determine a new relative rotation of the second linked element with respect to the first linked element.

11. The system of claim 10 further comprising an operator interface system, wherein the orientations of the virtual instruments are determined from the operator interface system.

12. A non-transitory machine-readable medium comprising a plurality of machine-readable instructions which when executed by one or more processors associated with a computer-assisted simulation system are adapted to cause the one or more processors to perform a method comprising:
identifying, from a plurality of linked elements, a first linked element connected by a joint to a second linked element;
determining a current relative rotation of the second linked element with respect to the first linked element;
determining if an angle of rotation associated with the current relative rotation is greater than a predetermined elastic limit for the joint; and
if the angle of rotation is greater than the predetermined elastic limit, determine a current plastic quaternion that represents a current angular plastic deformation of the joint.

13. The non-transitory machine-readable medium of claim 12 wherein the method performed by the one or more processors further includes displaying simulated motion of the first and second linked elements based on the current plastic quaternion.

14. The non-transitory machine-readable medium of claim 12 wherein the plurality of linked elements models a surgical suture.

15. The non-transitory machine-readable medium of claim 12 wherein the method performed by the one or more processors further includes receiving a material property parameter for the first and second linked elements and wherein determining the current relative rotation of the second linked element with respect to the first linked element includes determining the current relative rotation based on a torque applied to the joint and the material property parameter.

16. The non-transitory machine-readable medium of claim 12 wherein determining the current relative rotation includes receiving a first quaternion representing rotation of the first linked element and receiving a second quaternion representing rotation of the second linked element.

17. The non-transitory machine-readable medium of claim 16 wherein determining the current relative rotation includes representing the current relative rotation as a third quaternion.

18. The non-transitory machine-readable medium of claim 12 wherein determining if the angle of rotation associated with the current relative rotation is greater than a predetermined elastic limit for the joint includes receiving a prior plastic quaternion for the joint and determining a deviated quaternion representing a deviation between the current relative rotation and the prior plastic quaternion.

19. The non-transitory machine-readable medium of claim 12 wherein the method performed by the one or more processors further includes determining a plastic angle of rotation and determining if the plastic angle of rotation is greater than a predetermined plastic limit for the joint.

20. The non-transitory machine-readable medium of claim 19 wherein if the plastic angle of rotation is greater than the predetermined plastic limit, the method further comprises determining a quaternion that represents the current angular plastic deformation based on the predetermined plastic limit.

21. The non-transitory machine-readable medium of claim 12 wherein the method performed by the one or more processors further includes
receiving orientations of virtual instruments and
determining a new relative rotation of the second linked element with respect to the first linked element.

22. The non-transitory machine-readable medium of claim 21 wherein the orientations of the virtual instruments are received from an operator interface system.
